(19) United States
(12) Patent Application Publication
(10) Pub. No.: US 2026/0217133 A1
(43) Pub. Date: Jul. 30, 2026

(54) VEHICLE CONTROL APPARATUS AND VEHICLE CONTROL METHOD

(71) Applicant: SUBARU CORPORATION, Tokyo (JP)

(72) Inventors: Yosuke TAKEBAYASHI, Tokyo (JP); Takeshi YONEDA, Tokyo (JP); Masaru KOGURE, Tokyo (JP); Masahiro SAITO, Tokyo (JP); Naoto YABUKI, Tokyo (JP); Norio OOWADA, Tokyo (JP)

(21) Appl. No.: 18/724,175

(22) PCT Filed: Feb. 10, 2023
(86) PCT No.: PCT/JP2023/004580

§ 371 Date: Jun. 25, 2024

(51) Int. Cl. B60L 15/20

(52) U.S. Cl. CPC B60L 15/20; B60L 2240/12; B60L 2240/16; B60L 2240/423; B60L 2240/465; B60L 2240/647

(57) ABSTRACT

A vehicle control apparatus according to an aspect of the disclosure includes a control unit configured to derive a target torque by adding, to a requested torque corresponding to an acceleration request, a fluctuation torque that fluctuates cyclically, and control a torque of a motor, based on the derived target torque. The control unit is configured to change one or more of a fluctuation range of the fluctuation torque, a cycle of the fluctuation torque, and a waveform of the fluctuation torque, based on any of a speed of a vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.

### TECHNICAL FIELD

The disclosure relates to a vehicle control apparatus to be mounted on a vehicle and to a vehicle control method.

### BACKGROUND ART

Various techniques for safely operating a vehicle have been proposed (for example, see Patent Literatures 1 and 2).

### CITATION LIST

### Patent Literature

Patent Literature 1: Japanese Unexamined Patent Application Publication No. 2017-055618
Patent Literature 2: Japanese Unexamined Patent Application Publication No. 2011-205799

### SUMMARY OF INVENTION

An aspect of the disclosure provides a vehicle control apparatus configured to control a vehicle that travels by driving a motor. The vehicle control apparatus includes a control unit configured to derive a target torque by adding, to a requested torque corresponding to an acceleration request, a fluctuation torque that fluctuates cyclically, and control a torque of the motor, based on the derived target torque. The control unit is configured to change one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.

An aspect of the disclosure provides a vehicle control method that controls a vehicle that travels by driving a motor. The vehicle control method includes two acts as follows.
(1) Deriving a target torque by adding, to a requested torque corresponding to an acceleration request, a fluctuation torque that fluctuates cyclically, and controlling a torque of the motor, based on the derived target torque.
(2) Changing one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.

### BRIEF DESCRIPTION OF DRAWINGS

The accompanying drawings are included to provide a further understanding of the disclosure, and are incorporated in and constitute a part of this specification. The drawings illustrate embodiments and, together with the specification, serve to explain the principles of the disclosure.

FIG. 1 is a diagram illustrating an example of a functional block of a vehicle including a vehicle controller according to an embodiment of the disclosure.

FIG. 2 is a diagram illustrating an example of a procedure of deriving a target torque in a travel controller of FIG. 1.

FIG. 3 is a diagram illustrating an example of a procedure of deriving a fluctuation torque in step S104 of FIG. 2.

FIG. 4 (A) is a diagram illustrating an example of a waveform of a requested torque. FIG. 4 (B) is a diagram illustrating an example of a waveform of the fluctuation torque. FIG. 4 (C) is a diagram illustrating an example of a waveform of the target torque.

FIG. 5 (A) is a diagram illustrating an example of the waveform of the requested torque. FIG. 5 (B) is a diagram illustrating an example of the waveform of the fluctuation torque. FIG. 5 (C) is a diagram illustrating an example of the waveform of the target torque.

FIG. 6 is a diagram illustrating a modification example of the procedure of deriving the fluctuation torque in step S104 of FIG. 2.

FIG. 7 is a diagram illustrating a modification example of the procedure of deriving the fluctuation torque in step S104 of FIG. 2.

FIG. 8 is a diagram illustrating a modification example of the procedure of deriving the fluctuation torque in step S104 of FIG. 2.

FIG. 9 is a diagram illustrating a modification example of the procedure of deriving the fluctuation torque in step S104 of FIG. 2.

FIG. 10 is a diagram illustrating a modification example of the procedure of deriving the fluctuation torque in step S104 of FIG. 2.

FIG. 11 is a diagram illustrating a modification example of the procedure of deriving the fluctuation torque in step S104 of FIG. 2.

FIG. 12 is a diagram illustrating a modification example of the procedure of deriving the fluctuation torque in step S104 of FIG. 2.

FIG. 13 is a diagram illustrating a modification example of the procedure of deriving the fluctuation torque in step S104 of FIG. 2.

FIG. 14 (A) is a diagram illustrating an example of the waveform of the requested torque. FIG. 14 (B) is a diagram illustrating an example of the waveform of the fluctuation torque. FIG. 14 (C) is a diagram illustrating an example of the waveform of the target torque.

FIG. 15 is a diagram illustrating a modification example of the functional block of the vehicle of FIG. 1.

FIG. 16 is a diagram illustrating a modification example of the procedure of deriving the fluctuation torque in step S104 of FIG. 2.

FIG. 17 is a diagram illustrating a modification example of the procedure of deriving the fluctuation torque in step S104 of FIG. 2.

FIG. 18 is a diagram illustrating a schematic configuration example of a vehicle control system according to an application example of the disclosure.

FIG. 19 is a diagram illustrating an example of a functional block of a vehicle of FIG. 18.

FIG. 20 is a diagram illustrating an example of a functional block of a server apparatus of FIG. 18.

### MODES FOR CARRYING OUT THE INVENTION

A vehicle that travels by motor driving is smoother in a motor output than an engine output, making it difficult for a driver to grasp a slip of the vehicle. Accordingly, the driver may not recognize a possibility of the slip of the vehicle, allowing the vehicle to be at risk. It is desirable to provide a vehicle control apparatus and a vehicle control method that make it possible to cause a driver to recognize a possibility of a slip of a vehicle.

In the following, some example embodiments of the disclosure are described in detail with reference to the accompanying drawings. Note that the following description is directed to illustrative examples of the disclosure and not to be construed as limiting to the disclosure. Factors including, without limitation, numerical values, shapes, materials, components, positions of the components, and how the components are coupled to each other are illustrative only and not to be construed as limiting to the disclosure. Further, elements in the following example embodiments which are not recited in a most-generic independent claim of the disclosure are optional and may be provided on an as-needed basis. The drawings are schematic and are not intended to be drawn to scale. Throughout the present specification and the drawings, elements having substantially the same function and configuration are denoted with the same reference numerals to avoid any redundant description. In addition, elements that are not directly related to any embodiment of the disclosure are unillustrated in the drawings.

### 1. Embodiment

### Configuration Example

FIG. 1 illustrates a schematic configuration example of a vehicle 1 including a control unit 20 according to an embodiment of the disclosure. The control unit 20 corresponds to a specific example of a “control unit” according to the disclosure. The vehicle 1 is configured to travel by driving a motor. As illustrated in FIG. 1, the vehicle 1 includes, for example, a sensor unit 10, the control unit 20, and a motor 30.

The sensor unit 10 includes various sensors mounted on the vehicle 1. As illustrated in FIG. 1, the sensor unit 10 includes, for example, an accelerator position sensor 11, a vehicle speed sensor 12, an acceleration sensor 13, an angular velocity sensor 14, a steering angle sensor 15, a steering torque sensor 16, and a road surface friction coefficient sensor 17. The sensor unit 10 may include any sensor other than those described above.

The accelerator position sensor 11 is configured to detect an accelerator position, based on a depression amount of an accelerator pedal. The accelerator position sensor 11 is configured to output, to the control unit 20, time-series data (accelerator position data) on the detected accelerator position.

The vehicle speed sensor 12 is configured to detect a speed (a vehicle speed) of the vehicle 1. The vehicle speed sensor 12 is configured to output, to the control unit 20, time-series data (vehicle speed data) on the detected vehicle speed. The acceleration sensor 13 is configured to detect an acceleration applied to the vehicle 1. The acceleration sensor 13 is configured to output, to the control unit 20, time-series data (acceleration data) on the detected accelerations in three directions. The angular velocity sensor 14 is configured to detect an angular velocity of the vehicle 1. The angular velocity sensor 14 is configured to output, to the control unit 20, time-series data (angular velocity data) on the three detected angular velocities (a yaw angular velocity, a roll angular velocity, and a pitch angular velocity).

The steering angle sensor 15 is configured to detect a steering angle (a steering angle) of a steering wheel of the vehicle 1. The steering angle sensor 15 is configured to output, to the control unit 20, time-series data (steering angle data) on the detected steering angle. The steering torque sensor 16 is configured to detect the steering torque generated by a steering operation performed by a driver. The steering torque sensor 16 is configured to output, to the control unit 20, time-series data (steering torque data) on the detected steering torque.

The road surface friction coefficient sensor 17 is configured to estimate, for example, a friction coefficient of a road surface in front of the vehicle 1. The road surface friction coefficient sensor 17 includes, for example, a non-contact sensor such as a camera that captures an image of the front of the vehicle 1, a temperature sensor (an outside air temperature sensor or a road surface temperature sensor), a near-infrared sensor, or a laser-light sensor (TOF (Time of Flight) sensor. The road surface friction coefficient sensor 17 is configured to estimate the road surface friction coefficient, based on, for example, a detection result of the non-contact sensor. The road surface friction coefficient sensor 17 is configured to output, to the control unit 20, time-series data (road surface friction coefficient data) on the road surface friction coefficient obtained by the estimation. The road surface friction coefficient sensor 17 may be, for example, a road surface sensor that directly measures the road surface friction coefficient.

The control unit 20 is configured to control the vehicle 1 as a whole. The control unit 20 is, for example, a so-called ECU (Electronic Control Unit), and includes, for example, one or more processors and one or more memories. The control unit 20 may include, for example, a CPU (Central Processing Unit). The control unit 20 is configured to control the vehicle 1 as a whole by, for example, executing a program stored in a storage.

The control unit 20 is configured to control the vehicle 1 that travels by driving the motor. The control unit 20 includes, for example, a travel controller 21 as illustrated in FIG. 1. The travel controller 21 is configured to control traveling of the vehicle 1 (for example, a torque of the motor 30). As illustrated in FIG. 1, the travel controller 21 includes, for example, a requested torque deriving unit 22, a fluctuation torque deriving unit 23, and a motor torque controlling unit 24.

The requested torque deriving unit 22 is configured to derive a requested torque corresponding to an acceleration request. The acceleration request refers to a depression of the accelerator pedal or a variation in the depression amount of the accelerator pedal. The acceleration request may be made by the driver during manual driving, or may be made by the travel controller 21 during automated driving. The requested torque deriving unit 22 is configured to derive a torque amount (the requested torque) to be generated by the motor 30, based on the accelerator position data obtained by the accelerator position sensor 11.

The fluctuation torque deriving unit 23 is configured to derive the fluctuation torque that fluctuates cyclically. The fluctuation torque is to cause the driver to recognize a possibility of a slip of the vehicle 1 by intentionally changing a behavior of the vehicle 1. The fluctuation torque deriving unit 23 is configured to cause a fluctuation range, a cycle, and a waveform of the fluctuation torque to be constant regardless of a magnitude of the requested torque.

The fluctuation torque deriving unit 23 is configured to change one or more of the fluctuation range, the cycle, and the waveform of the fluctuation torque, based on the vehicle speed data obtained by the vehicle speed sensor 12 mounted on the vehicle 1. In one example, the fluctuation torque deriving unit 23 is configured to set the fluctuation range of the fluctuation torque to zero or a small value when the possibility of the slip of the vehicle 1 is low, and set the fluctuation range of the fluctuation torque to a large value when the possibility of the slip of the vehicle 1 is high. In one example, the fluctuation torque deriving unit 23 is configured to set the fluctuation cycle of the fluctuation torque to a large value when the possibility of the slip of the vehicle 1 is low, and set the fluctuation cycle of the fluctuation torque to a small value when the possibility of the slip of the vehicle 1 is high. In one example, the fluctuation torque deriving unit 23 is configured to set the waveform of the fluctuation torque to a smooth waveform (for example, a sine wave) when the possibility of the slip of the vehicle 1 is low, and set the waveform of the fluctuation torque to a rectangular shape (for example, a pulsed shape) when the possibility of the slip of the vehicle 1 is high.

The motor torque controlling unit 24 is configured to derive the target torque by adding the fluctuation torque to the requested torque, and control the torque of the motor 30 based on the derived target torque. The motor 30 is configured to drive steered wheels of the vehicle 1, and drive the steered wheels of the vehicle 1 in accordance with the target torque inputted from the motor torque controlling unit 24.

The control unit 20 further includes an electric power steering (EPS) controller. The vehicle 1 further includes an EPS motor coupled to the EPS controller. The EPS motor is configured to add, to a steering shaft, a steering assist torque corresponding to a drive signal outputted from the EPS controller. The EPS controller derives the steering assist torque adapted to assist the steering torque generated by the steering operation performed by the driver, and sets an EPS torque corresponding to the derived steering assist torque. The EPS controller so outputs the control signal to the EPS motor that the output torque of the EPS motor becomes the set EPS torque.

### Operation

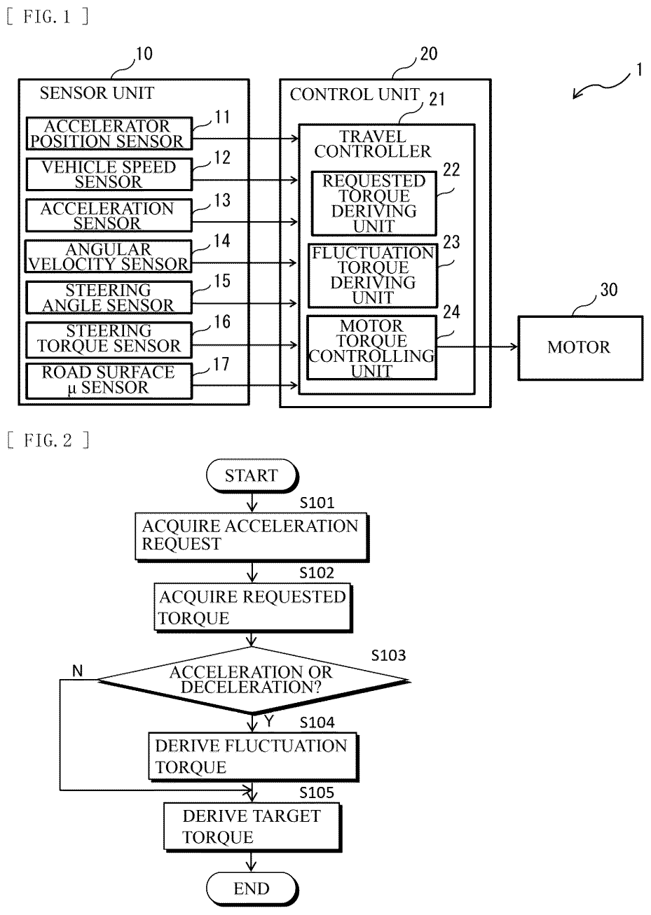

Next, an operation of the travel controller 21 will be described with reference to FIG. 2. FIG. 2 is a diagram illustrating an example of a procedure of deriving the target torque.

The travel controller 21 acquires the acceleration request from the accelerator position sensor 11 (step S101). Next, when the acceleration request is acquired from the accelerator position sensor 11 (step S102), the travel controller 21 derives the fluctuation torque (step S104) if the acquired acceleration request is a request for acceleration or a request for deceleration (step S103: Y). If the acquired acceleration request is not the request for acceleration or the request for deceleration (step S103: N), or when the fluctuation torque is derived in step S104, the travel controller 21 derives the target torque (step S105). When the acquired acceleration request is not the request for acceleration or the request for deceleration, the travel controller 21 sets, as the target torque, the requested torque corresponding to the acceleration request. When the fluctuation torque is derived in step S104, the travel controller 21 derives the target torque by adding, to the requested torque corresponding to the acceleration request, the fluctuation torque that fluctuates cyclically. The travel controller 21 controls the torque of the motor 30, based on the derived target torque. At this time, the travel controller 21 changes one or more of the fluctuation range, the cycle, and the waveform of the fluctuation torque, based on the vehicle speed obtained by the vehicle speed sensor 12 mounted on the vehicle 1. Further, the travel controller 21 causes the fluctuation range, the cycle, and the waveform of the fluctuation torque to be constant regardless of the magnitude of the requested torque.

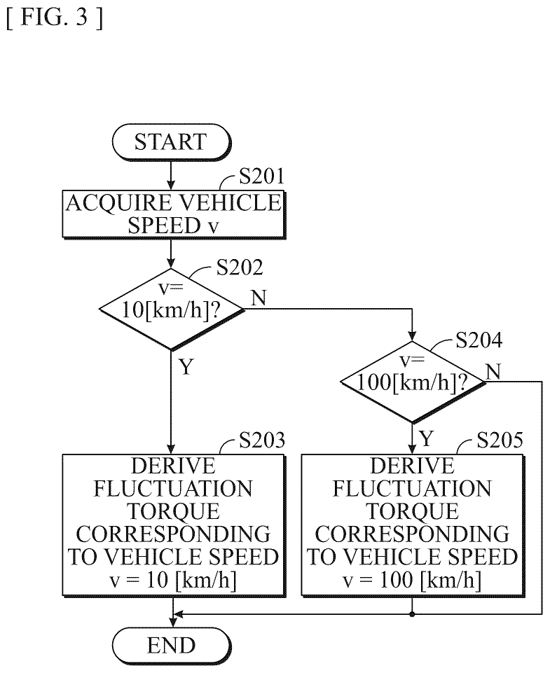

Next, a method of deriving the fluctuation torque in step S104 will be described. FIG. 3 is a diagram illustrating an example of a procedure of deriving the fluctuation torque in step S104.

First, the travel controller 21 acquires the vehicle speed v (the vehicle speed data) from the vehicle speed sensor 12 (step S201). Next, if the vehicle speed v is 10 km/h (step S202: Y), the travel controller 21 derives the fluctuation torque corresponding to the vehicle speed v=10 km/h (step S203). If the vehicle speed v is 100 km/h (step S202: N and step S204: Y), the travel controller 21 derives the fluctuation torque corresponding to the vehicle speed v=100 km/h (step S205).

For the derivation of the fluctuation torque, for example, it is possible to use a mathematical function having the vehicle speed v as a variable, or use table data in which the fluctuation torque is associated with each vehicle speed v. A method of deriving the fluctuation torque is not limited to the method illustrated in FIG. 3.

### Effect

Next, an effect of the control unit 20 according to an embodiment of the disclosure will be described.

In the present embodiment, the target torque is derived by adding, to the requested torque corresponding to the acceleration request, the fluctuation torque that fluctuates cyclically, and the torque of the motor 30 is controlled based on the derived target torque. At this time, one or more of the fluctuation range, the cycle, and the waveform of the fluctuation torque are changed based on the vehicle speed obtained by the vehicle speed sensor 12 mounted on the vehicle 1. Thus, the steered wheels of the vehicle 1 are driven in accordance with the target torque, and the behavior of the vehicle 1 is varied in accordance with the target torque.

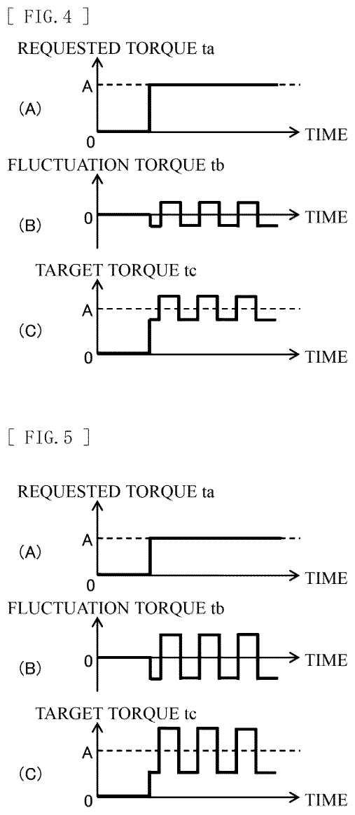

FIG. 4 (A) illustrates an example of a waveform of the requested torque. FIG. 4 (B) illustrates an example of the waveform of the fluctuation torque. FIG. 4 (C) illustrates an example of a waveform of the target torque. When the requested torque ta becomes A (a constant value) at a certain timing, a rectangular wave is generated as the fluctuation torque tb corresponding to the vehicle speed v, and the target torque tc having a waveform in which the fluctuation torque tb is added to the requested torque ta is generated. The travel controller 21 outputs, to the motor 30, the target torque tc having the waveform as illustrated in FIG. 4C. Accordingly, the motor 30 drives the steered wheels of the vehicle 1 in accordance with the target torque tc inputted from the travel controller 21. Consequently, the behavior of the vehicle 1 varies in accordance with the target torque tc, making it possible for the driver to feel the varying behavior of the vehicle 1.

Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

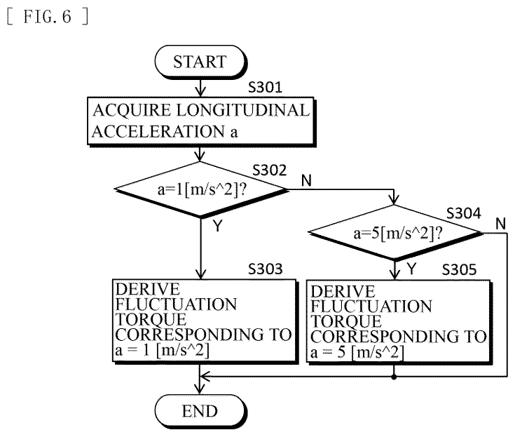

FIG. 5 (A) illustrates an example of the waveform of the requested torque. FIG. 5 (B) illustrates an example of the waveform of the fluctuation torque. FIG. 5 (C) illustrates an example of the waveform of the target torque. FIG. 5 (B) exemplifies the fluctuation torque tb to be generated when the vehicle speed v is higher than the vehicle speed v in FIG. 4 (B). A peak value of the fluctuation torque tb illustrated in FIG. 5 (B) is larger than a peak value of the fluctuation torque tb illustrated in FIG. 4 (B). Thus, the change in the behavior of the vehicle 1 that occurs based on the target torque tc illustrated in FIG. 5 (C) becomes larger than the change in the behavior of the vehicle 1 that occurs based on the target torque tc illustrated in FIG. 4 (C). Accordingly, it is possible to easily cause the driver to feel the varying behavior of the vehicle 1 when the vehicle 1 moves at a high speed and the possibility of the slip of the vehicle 1 is increased.

In the present embodiment, the fluctuation range, the cycle, and the waveform of the fluctuation torque are constant regardless of the magnitude of the requested torque. Accordingly, it is possible to cause the driver to recognize the possibility of the slip of the vehicle 1 even upon a state of a road surface in which the possibility of the slip of the vehicle 1 is increased (for example, a snow surface or an ice surface), even when the requested torque is small.

### 2. Modification Examples

Although the disclosure has been described with reference to an embodiment, the disclosure is not limited to the embodiment, and various modifications can be made.

### Modification Example A

In the above-described embodiment, the travel controller 21 (the fluctuation torque deriving unit 23) may be configured to change one or more of the fluctuation range, the cycle, and the waveform of the fluctuation torque, based on a longitudinal acceleration, instead of the vehicle speed. The longitudinal acceleration is an acceleration to be applied in a front-rear direction of the vehicle 1. The travel controller 21 (the fluctuation torque deriving unit 23) derives the longitudinal acceleration, based on the acceleration data obtained by the acceleration sensor 13.

FIG. 6 is a diagram illustrating an example of a procedure of deriving the fluctuation torque in step S104. First, the travel controller 21 derives the longitudinal acceleration a, based on the acceleration data obtained by the acceleration sensor 13 (step S301). Next, if the longitudinal acceleration a is 1 m/s² (step S302: Y), the travel controller 21 derives the fluctuation torque corresponding to the longitudinal acceleration a=1 m/s² (step S303). If the longitudinal acceleration a is 5 m/s² (step S302: N and step S304: Y), the travel controller 21 derives the fluctuation torque corresponding to the longitudinal acceleration a=5 m/s² (step S305).

For the derivation of the fluctuation torque, for example, it is possible to use a mathematical function having the longitudinal acceleration a as a variable, or use table data in which the fluctuation torque is associated with each longitudinal acceleration. A method of deriving the fluctuation torque is not limited to the method illustrated in FIG. 6.

In the present modification example, one or more of the fluctuation range, the cycle, and the waveform of the fluctuation torque are changed based on the acceleration obtained by the acceleration sensor 13 mounted on the vehicle 1. Thus, the steered wheels of the vehicle 1 are driven in accordance with the target torque, and the behavior of the vehicle 1 varies in accordance with the target torque. Consequently, it is possible to make the driver feel the varying behavior of the vehicle 1. Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

### Modification Example B

In the above-described embodiment, the travel controller 21 (the fluctuation torque deriving unit 23) may be configured to change one or more of the fluctuation range, the cycle, and the waveform of the fluctuation torque, based on a vehicle body slip angular velocity, instead of the vehicle speed. It is possible to derive the vehicle body slip angular velocity, for example, using the following equation. The travel controller 21 (the fluctuation torque deriving unit 23) derives the vehicle body slip angular velocity, based on, for example, the angular velocity data obtained by the angular velocity sensor 14, the acceleration data obtained by the acceleration sensor 13, and the speed data obtained by the vehicle speed sensor 12.

$$b = γ - Ay / v$$

b: vehicle body slip angular velocity
Ay: lateral acceleration
γ: yaw angular velocity
v: speed of the vehicle 1

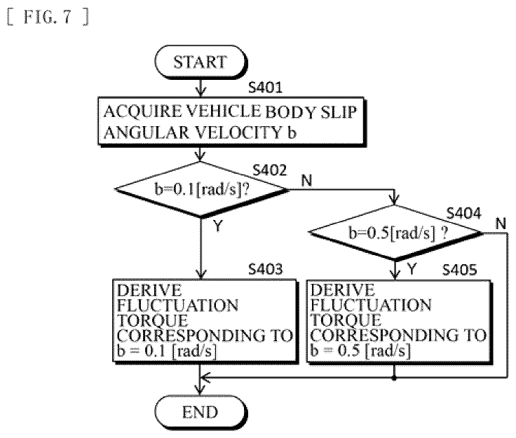

FIG. 7 is a diagram illustrating an example of a procedure of deriving the fluctuation torque in step S104. First, the travel controller 21 derives the vehicle body slip angular velocity b, based on the angular velocity data obtained by the angular velocity sensor 14, the acceleration data obtained by the acceleration sensor 13, and the speed data obtained by the vehicle speed sensor 12 (step S401). Next, if the vehicle body slip angular velocity b is 0.1 rad/s (step S402: Y), the travel controller 21 derives the fluctuation torque corresponding to the vehicle body slip angular velocity b=0.1 rad/s (step S403). If the vehicle body slip angular velocity b is 0.5 rad/s (step S402: N and step S404: Y), the travel controller 21 derives the fluctuation torque corresponding to the vehicle body slip angular velocity b=0.5 rad/s (step S405).

For the derivation of the fluctuation torque, for example, it is possible to use a mathematical function having the vehicle body slip angular velocity b as a variable, or use table data in which the fluctuation torque is associated with each vehicle body slip angular velocity b. A method of deriving the fluctuation torque is not limited to the method illustrated in FIG. 7.

In the present modification example, one or more of the fluctuation range, the cycle, and the waveform of the fluctuation torque are changed based on the angular velocity, the acceleration, and the speed respectively respectively obtained by the angular velocity sensor 14, the acceleration sensor 13, and the vehicle speed sensor 12 mounted on the vehicle 1. Thus, the steered wheels of the vehicle 1 are driven in accordance with the target torque, and the behavior of the vehicle 1 varies in accordance with the target torque. Consequently, it is possible to make the driver feel the varying behavior of the vehicle 1. Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

### Modification Example C

In the above-described embodiment, the travel controller 21 (the fluctuation torque deriving unit 23) may be configured to change one or more of the fluctuation range, the cycle, and the waveform of the fluctuation torque, based on a self-aligning torque, instead of the vehicle speed. The travel controller 21 (the fluctuation torque deriving unit 23) is configured to derive the self-aligning torque, based on any of the steering angle, the steering torque, and the steering assist torque. The self-aligning torque refers to a restoring force generated in a steering mechanism when wheels rotate. The travel controller 21 (the fluctuation torque deriving unit 23) derives the self-aligning torque, based on, for example, any one of the steering angle data obtained by the steering angle sensor 15, the steering torque data obtained by the steering torque sensor 16, and the steering assist torque derived by the EPS controller.

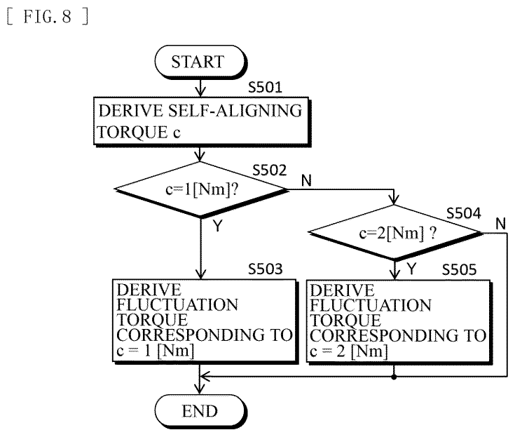

FIG. 8 is a diagram illustrating an example of a procedure of deriving the fluctuation torque in step S104. First, the travel controller 21 derives the self-aligning torque c, based on any one of the steering angle data obtained by the steering angle sensor 15, the steering torque data obtained by the steering torque sensor 16, and the steering assist torque derived by the EPS controller (step S501). Next, if the self-aligning torque c is 1 Nm (step S502: Y), the travel controller 21 derives the fluctuation torque corresponding to the self-aligning torque c=1 Nm (step S503). If the self-aligning torque c is 2 Nm (step S502: N and step S504: Y), the travel controller 21 derives the fluctuation torque corresponding to the self-aligning torque c=2 Nm (step S505).

For the derivation of the fluctuation torque, for example, it is possible to use a mathematical function having the self-aligning torque c as a variable, or use table data in which the fluctuation torque is associated with each self-aligning torque c. A method of deriving the fluctuation torque is not limited to the method illustrated in FIG. 8.

In the present modification example, one or more of the fluctuation range, the cycle, and the waveform of the fluctuation torque are changed based on the self-aligning torque. Thus, the steered wheels of the vehicle 1 are driven in accordance with the target torque, and the behavior of the vehicle 1 varies in accordance with the target torque. Consequently, it is possible to make the driver feel the varying behavior of the vehicle 1. Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

### Modification Example D

In the above-described embodiment, the travel controller 21 (the fluctuation torque deriving unit 23) may be configured to change one or more of the fluctuation range, the cycle, and the waveform of the fluctuation torque, based on the road surface friction coefficient, instead of the vehicle speed. The travel controller 21 (the fluctuation torque deriving unit 23) derives the road surface friction coefficient, based on, for example, a detection result of the road surface friction coefficient sensor 17.

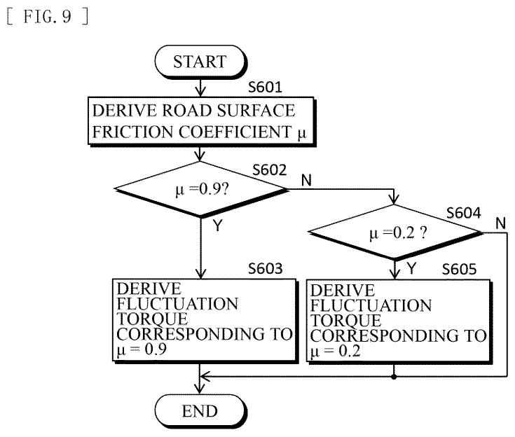

FIG. 9 is a diagram illustrating an example of a procedure of deriving the fluctuation torque in step S104. First, the travel controller 21 derives the road surface friction coefficient μ, based on the detection result of the road surface friction coefficient sensor 17 (step S601). Next, if the road surface friction coefficient μ is 0.9 (step S602: Y), the travel controller 21 derives the fluctuation torque corresponding to the road surface friction coefficient μ=0.9 (step S603). If the road surface friction coefficient μ is 0.2 (step S602: N and step S604: Y), the travel controller 21 derives the fluctuation torque corresponding to the road surface friction coefficient μ=0.2 (step S605).

For the derivation of the fluctuation torque, for example, it is possible to use a mathematical function having the road surface friction coefficient μ as a variable, or use table data in which the fluctuation torque is associated with each road surface friction coefficient μ. A method of deriving the fluctuation torque is not limited to the method illustrated in FIG. 9.

In the present modification example, one or more of the fluctuation range, the cycle, and the waveform of the fluctuation torque are changed based on the road surface friction coefficient obtained by the road surface friction coefficient sensor 17 mounted on the vehicle 1. Thus, the steered wheels of the vehicle 1 are driven in accordance with the target torque, and the behavior of the vehicle 1 varies in accordance with the target torque. Consequently, it is possible to make the driver feel the varying behavior of the vehicle 1. Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

### Modification Example E

In the above-described embodiment, the travel controller 21 (the fluctuation torque deriving unit 23) may be configured to change one or more of the fluctuation range, the cycle, and the waveform of the fluctuation torque, based on a turning state of the vehicle 1, instead of the vehicle speed. The travel controller 21 (the fluctuation torque deriving unit 23) may be configured to change one or more of the fluctuation range, the cycle, and the waveform of the fluctuation torque based on, for example, a lateral acceleration that is one of indices of the turning state of the vehicle 1. The travel controller 21 (the fluctuation torque deriving unit 23) derives the lateral acceleration, based on, for example, the detection result of the acceleration sensor 13.

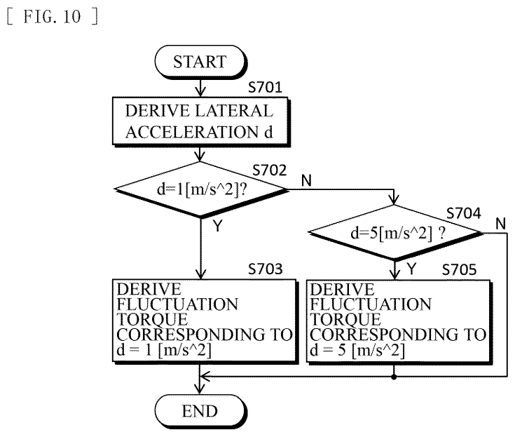

FIG. 10 is a diagram illustrating an example of a procedure of deriving the fluctuation torque in step S104. First, the travel controller 21 derives the lateral acceleration d, based on the detection result of the acceleration sensor 13 (step S701). Next, if the lateral acceleration d is 1 m/s² (step S702: Y), the travel controller 21 derives the fluctuation torque corresponding to the lateral acceleration d=1 m/s² (step S703). If the lateral acceleration d is 5 m/s² (step S702: N and step S704: Y), the travel controller 21 derives the fluctuation torque corresponding to the lateral acceleration d=5 m/s² (step S705).

For the derivation of the fluctuation torque, for example, it is possible to use a mathematical function having the lateral acceleration d as a variable, or use table data in which the fluctuation torque is associated with each lateral acceleration d. A method of deriving the fluctuation torque is not limited to the method illustrated in FIG. 10.

In the present modification example, the travel controller 21 (the fluctuation torque deriving unit 23) may be configured to change one or more of the fluctuation range, the cycle, and the waveform of the fluctuation torque, based on, for example, the steering angle that is one of indices of the turning state of the vehicle 1.

In the present modification example, the travel controller 21 (the fluctuation torque deriving unit 23) may be configured to change one or more of the fluctuation range, the cycle, and the waveform of the fluctuation torque, based on, for example, the yaw angular velocity that is one of indices of the turning state of the vehicle 1.

In the present modification example, one or more of the fluctuation range, the cycle, and the waveform of the fluctuation torque are changed based on the turning state of the vehicle 1. Thus, the steered wheels of the vehicle 1 are driven in accordance with the target torque, and the behavior of the vehicle 1 varies in accordance with the target torque. Consequently, it is possible to make the driver feel the varying behavior of the vehicle 1. Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

### Modification Example F

In the above-described embodiment, the travel controller 21 (the fluctuation torque deriving unit 23) may be configured to change one or more of the fluctuation range, the cycle, and the waveform of the fluctuation torque, based on a torsional resonance frequency of the wheels of the vehicle 1, instead of the vehicle speed. The travel controller 21 (the fluctuation torque deriving unit 23) acquires the torsional resonance frequency by, for example, reading the torsional resonance frequency of the wheels of the vehicle 1 from a memory in the control unit 20.

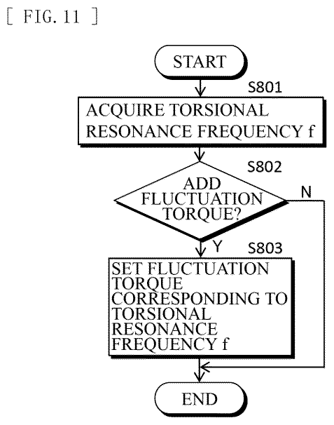

FIG. 11 illustrates an example of a procedure of deriving the fluctuation torque in step S104. First, the travel controller 21 acquires the torsional resonance frequency f of the wheels of the vehicle 1 from, for example, the memory in the control unit 20 (step S801). Next, if the setting of adding the fluctuation torque to the requested torque is made (step S802: Y), the travel controller 21 derives the fluctuation torque corresponding to the torsional resonance frequency f (step S803). For example, the travel controller 21 sets the cycle of the fluctuation torque to the reciprocal of the torsional resonance frequency f. When the cycle of the fluctuation torque is equal to the reciprocal of the torsional resonance frequency f, the behavior (the fluctuation) of the vehicle 1 becomes more severe than when the cycle of the fluctuation torque is deviated from the reciprocal of the torsional resonance frequency f.

In the present modification example, one or more of the fluctuation range, the cycle, and the waveform of the fluctuation torque are changed based on the torsional resonance frequency f set in the travel controller 21. Thus, the steered wheels of the vehicle 1 are driven in accordance with the target torque, and the behavior of the vehicle 1 varies in accordance with the target torque. Consequently, it is possible to make the driver feel the varying behavior of the vehicle 1. Here, the addition of the fluctuation torque (that is, the change in the behavior of the vehicle 1) is performed when the possibility of the slip of the vehicle 1 is increased. Thus, it is possible to allow the driver to recognize the possibility of the slip of the vehicle 1 by causing the driver to feel the change in the behavior of the vehicle 1.

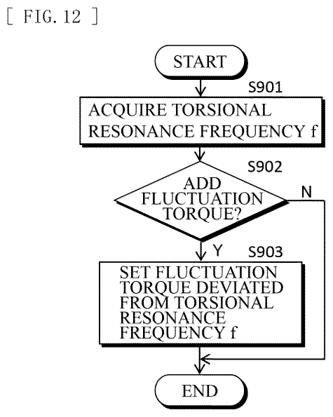

In the present modification example, the travel controller 21 (the fluctuation torque deriving unit 23) may, for example, set the cycle of the fluctuation torque to a value deviated from the reciprocal of the torsional resonance frequency f, as illustrated in FIG. 12 (step S903 in FIG. 12). The travel controller 21 (the fluctuation torque deriving unit 23) may, for example, bring the cycle of the fluctuation torque close to or away from the reciprocal of the torsional resonance frequency f. Even in such a case, it is possible to allow the driver to recognize the possibility of the slip of the vehicle 1 by causing the driver to feel the change in the behavior of the vehicle 1.

### Modification Example G

In the above-described embodiment and modification examples thereof, the travel controller 21 (the fluctuation torque deriving unit 23) may further correct the fluctuation torque in accordance with the magnitude of the requested torque.

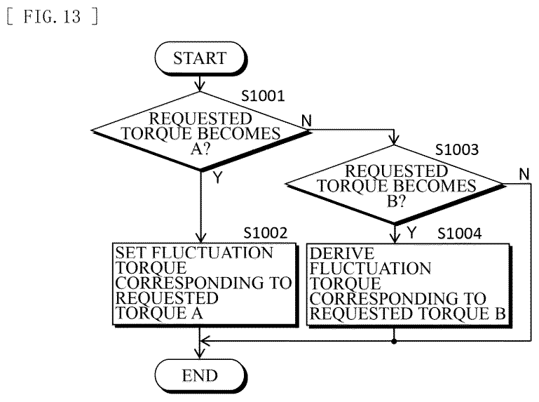

FIG. 13 illustrates an example of a procedure of deriving the fluctuation torque in step S104. The travel controller 21 derives the fluctuation torque by using any of the methods described in the above-described embodiment and modification examples thereof. If the requested torque becomes A (a constant value) (step S1001: Y), the travel controller 21 performs the correction corresponding to the requested torque A on the derived fluctuation torque (step S1002). If the requested torque becomes B (a constant value) (step S1003: Y), the travel controller 21 performs the correction corresponding to the requested torque B on the derived fluctuation torque (step S1004).

For the correction of the fluctuation torque, for example, it is possible to use a mathematical function having the requested torque as a variable, or use table data in which a correction coefficient is associated with each requested torque. A method of correcting the fluctuation torque is not limited to the method illustrated in FIG. 13.

In the present modification example, the fluctuation torque is corrected in accordance with the magnitude of the requested torque. In this case, for example, it is possible to cause the driver to recognize the possibility of the slip of the vehicle 1 even upon a state of a road surface in which the possibility of the slip of the vehicle 1 is increased (for example, a snow surface or an ice surface), even when the requested torque is small.

### Modification Example H

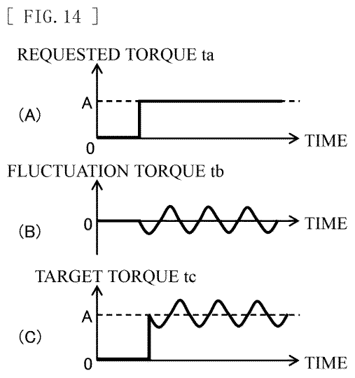

In the above-described embodiment and modification examples thereof, the waveform of the fluctuation torque tb may be, for example, a sine wave as illustrated in FIG. 14 (B). At this time, the waveform of the target torque tc is, for example, a sine wave as illustrated in FIG. 14 (C). Even in such a case, it is possible to cause the driver to recognize the possibility of the slip of the vehicle 1.

### Modification Example I

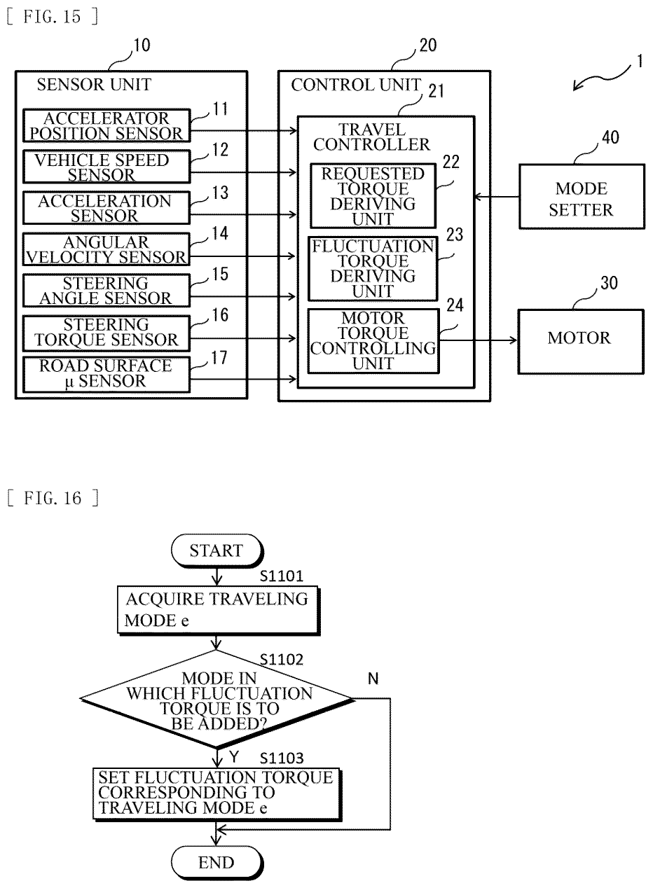

In the above-described embodiment and modification examples thereof, the vehicle 1 may further include a mode setter 40, for example, as illustrated in FIG. 15. The mode setter 40 is a user interface that accepts setting of a traveling mode in accordance with an input from the driver. The mode setter 40 includes, for example, a touch panel. The mode setter 40 is configured to output, to the travel controller 21, data on the received traveling mode. The travel controller 21 is configured to set the fluctuation torque, based on the traveling mode inputted from the mode setter 40. The travel controller 21 may be configured to determine whether to add the fluctuation torque to the requested torque, in accordance with the traveling mode.

FIG. 16 illustrates an example of a procedure of deriving the fluctuation torque in step S104. First, the travel controller 21 acquires the traveling mode e from the mode setter 40 (step S1101). Next, the travel controller 21 determines whether the acquired traveling mode e is a mode in which the fluctuation torque is to be added to the requested torque (step S1102). If the acquired traveling mode e is the mode in which the fluctuation torque is to be added to the requested torque (step S1102: Y), the travel controller 21 sets the fluctuation torque corresponding to the traveling mode e (step S1103). If the acquired traveling mode e is not the mode in which the fluctuation torque is to be added to the requested torque (step S1102: N), the travel controller 21 sets the requested torque as the target torque.

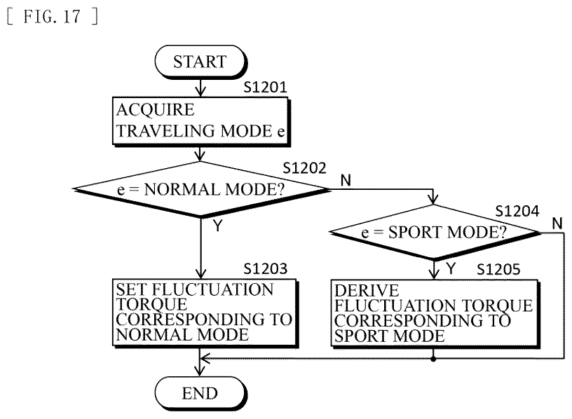

FIG. 17 illustrates an example of a procedure of deriving the fluctuation torque in step S104. First, the travel controller 21 acquires the traveling mode e from the mode setter 40 (step S1201). Next, if the acquired traveling mode e is a normal mode (step S1202: Y), the travel controller 21 sets the fluctuation torque corresponding to the normal mode (step S1203). At this time, the travel controller 21 may set, for example, the requested torque as the target torque. If the acquired traveling mode e is a sport mode (step S1202: N and step S1204: Y), the travel controller 21 sets the fluctuation torque corresponding to the sport mode (step S1205). At this time, the travel controller 21 may derive the target torque by, for example, adding the fluctuation torque to the requested torque.

In the present modification example, the fluctuation torque corresponding to the traveling mode is set. Specifically, whether to add the fluctuation torque to the requested torque is determined in accordance with the traveling mode. In such a case, it is possible to cause the driver to recognize the possibility of the slip of the vehicle 1 by adding the fluctuation torque to the requested torque in, for example, the sport mode in which high-speed movement is assumed.

### 3. Application Example

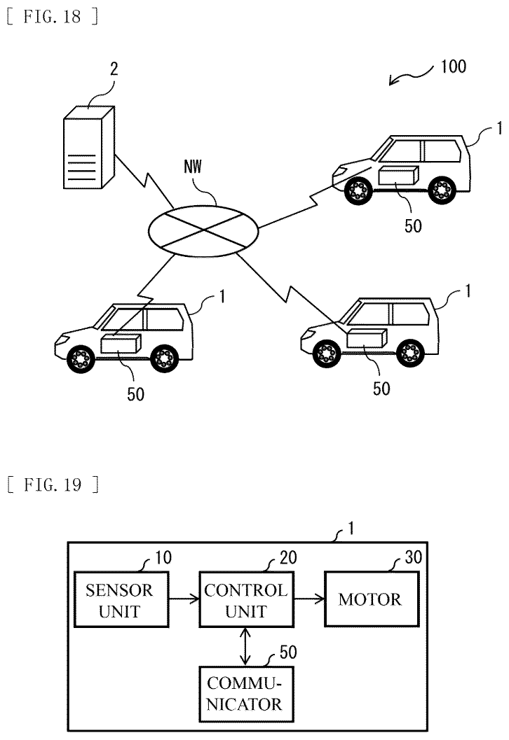

Next, an application example of the control unit 20 according to the above-described embodiment and modification examples thereof will be described. FIG. 18 illustrates a schematic configuration example of a vehicle control system 100 according to an application example of the disclosure. The vehicle control system 100 includes multiple vehicles 1 and a server device 2. The vehicles 1 and the server device 2 are coupled to a network NW.

The network NW is, for example, a communication network that performs communication using a communication protocol (TCP/IP) commonly used on the Internet. The network NW may be, for example, a secure network that performs communication using a communication protocol unique to the network.

The vehicles 1 are each configured to communicate with the server device 2 via the network NW. As illustrated in FIG. 19, the vehicles 1 each include, for example, the sensor unit 10, the control unit 20, the motor 30, and a communicator 50. The communicator 50 is a communication interface for communicating with the server device 2 via the network NW. For example, the communicator 50 exchanges data with the server device 2 via the network NW. The communicator 50 transmits, for example, various types of sensor data obtained by the sensor unit 10 to the server device 2 via the network NW. The communicator 50 receives, for example, the fluctuation torque data obtained by the server device 2 from the server device 2 via the network NW. The communicator 50 outputs, for example, the received fluctuation torque data to the control unit 20.

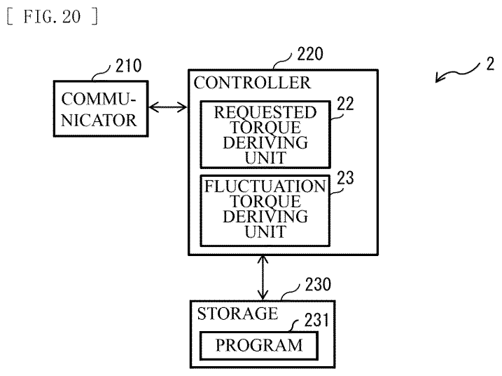

As illustrated in FIG. 20, the server device 2 includes, for example, a communicator 210, a controller 220, and a storage 230. The communicator 210 is a communication interface for communicating with each of the vehicles 1 via the network NW. For example, the communicator 210 exchanges data with each of the vehicles 1 via the network NW. The communicator 210 receives, for example, various types of sensor data obtained by the vehicles 1 from the vehicles 1 via the network NW. The communicator 210 outputs, for example, the received sensor data to the controller 220.

The storage 230 stores a program 231 to be executed by the controller 220. The storage 230 includes, for example, a RAM (Random Access Memory), a ROM (Read Only Memory), and a secondary storage device (such as a hard disk). The program 231 causes the controller 220 to execute a series of procedures of the requested torque deriving unit 22 and the fluctuation torque deriving unit 23.

The controller 220 includes, for example, a CPU (Central Processing Unit), and executes, for example, the program 231 stored in the storage 230. As illustrated in FIG. 20, the controller 220 includes, for example, the requested torque deriving unit 22 and the fluctuation torque deriving unit 23. The controller 220 executes a series of procedures of the requested torque deriving unit 22 and the fluctuation torque deriving unit 23. The controller 220 outputs, for example, the derived fluctuation torque data to the vehicle 1 via the communicator 210.

In the present application example, the target torque is derived by adding, to the requested torque corresponding to the acceleration request, the fluctuation torque derived by the server device 2, and the torque of the motor 30 is controlled based on the derived target torque. Thus, the steered wheels of the vehicle 1 are driven in accordance with the target torque, and the behavior of the vehicle 1 varies in accordance with the target torque. Consequently, the behavior of the vehicle 1 varies in accordance with the target torque tc, making it possible for the driver to feel the varying behavior of the vehicle 1. Accordingly, it is possible to cause the driver to recognize the possibility of the slip of the vehicle 1.

The effects described herein are merely examples, and the effects of the disclosure are not limited to the effects described herein. Accordingly, the disclosure may achieve other effects.

Further, the disclosure may take the following aspects.

(1)

A vehicle control apparatus that controls a vehicle that travels by driving a motor, the vehicle control apparatus including
a control unit configured to derive a target torque by adding, to a requested torque corresponding to an acceleration request, a fluctuation torque that fluctuates cyclically, and control a torque of the motor, based on the derived target torque, in which
the control unit is configured to change one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.
   (2)

The vehicle control apparatus according to (1), in which the control unit is configured to cause the fluctuation range of the fluctuation torque, the cycle of the fluctuation torque, and the waveform of the fluctuation torque to be constant regardless of a magnitude of the requested torque.

(3)

The vehicle control apparatus according to (1), in which the control unit is configured to correct the fluctuation range of the fluctuation torque, the cycle of the fluctuation torque, and the waveform of the fluctuation torque, in accordance with a magnitude of the requested torque.

(4)

The vehicle control apparatus according to any one of (1) to (3), in which the control unit is configured to determine whether to add the fluctuation torque to the requested torque, based on a traveling mode.

(5)

The vehicle control apparatus according to any one of (1) to (4), in which the control unit is configured to derive the self-aligning torque, based on any of a steering angle, a steering torque, and a steering assist torque.

(6)

The vehicle control apparatus according to any one of (1) to (4), in which the turning state includes any of a steering angle, a lateral acceleration, and a yaw angular velocity.

(7)

A vehicle control method that controls a vehicle that travels by driving a motor, the vehicle control method including:
deriving a target torque by adding, to a requested torque corresponding to an acceleration request, a fluctuation torque that fluctuates cyclically, and controlling a torque of the motor, based on the derived target torque; and
changing one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.
   (8)

The vehicle control method according to (7), further including
causing the fluctuation range of the fluctuation torque, the cycle of the fluctuation torque, and the waveform of the fluctuation torque to be constant regardless of a magnitude of the requested torque.
   (9)

The vehicle control method according to (7), further including
correcting the fluctuation range of the fluctuation torque, the cycle of the fluctuation torque, and the waveform of the fluctuation torque, in accordance with a magnitude of the requested torque.
   (10)

The vehicle control method according to any one of (7) to (9), further including
determining whether to add the fluctuation torque to the requested torque, based on a traveling mode.
   (11)

The vehicle control method according to any one of (7) to (10), further including
bringing the cycle of the fluctuation torque close to or away from a reciprocal of the torsional resonance frequency of the wheel mounted on the vehicle, based on any of the speed of the vehicle, the longitudinal acceleration of the vehicle, the vehicle body slip angular velocity of the vehicle, the self-aligning torque of the vehicle, the road surface friction coefficient, and the turning state of the vehicle.

The control unit 20 illustrated in FIGS. 1 and 15 is implementable by circuitry including at least one semiconductor integrated circuit such as at least one processor (e.g., a central processing unit (CPU)), at least one application specific integrated circuit (ASIC), and/or at least one field programmable gate array (FPGA). At least one processor is configurable, by reading instructions from at least one machine readable non-transitory tangible medium, to perform all or a part of functions of the control unit 20 illustrated in FIGS. 1 and 15. Such a medium may take many forms, including, but not limited to, any type of magnetic medium such as a hard disk, any type of optical medium such as a CD and a DVD, any type of semiconductor memory (i.e., semiconductor circuit) such as a volatile memory and a non-volatile memory. The volatile memory may include a DRAM and a SRAM, and the nonvolatile memory may include a ROM and a NVRAM. The ASIC is an integrated circuit (IC) customized to perform, and the FPGA is an integrated circuit designed to be configured after manufacturing in order to perform, all or a part of the functions of the control unit 20 illustrated in FIGS. 1 and 15.

1. A vehicle control apparatus configured to control a vehicle that travels by driving a motor, the vehicle control apparatus comprising
a control unit configured to derive a target torque by adding, to a requested torque corresponding to an acceleration request, a fluctuation torque that fluctuates cyclically, and control a torque of the motor, based on the derived target torque, wherein
the control unit is configured to change one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.

2. The vehicle control apparatus according to claim 1, wherein the control unit is configured to cause the fluctuation range of the fluctuation torque, the cycle of the fluctuation torque, and the waveform of the fluctuation torque to be constant regardless of a magnitude of the requested torque.

3. The vehicle control apparatus according to claim 1, wherein the control unit is configured to correct the fluctuation range of the fluctuation torque, the cycle of the fluctuation torque, and the waveform of the fluctuation torque, in accordance with a magnitude of the requested torque.

4. The vehicle control apparatus according to claim 1, wherein the control unit is configured to determine whether to add the fluctuation torque to the requested torque, based on a traveling mode.

5. The vehicle control apparatus according to claim 1, wherein the control unit is configured to derive the self-aligning torque, based on any of a steering angle, a steering torque, and a steering assist torque.

6. The vehicle control apparatus according to claim 1, wherein the turning state comprises any of a steering angle, a lateral acceleration, and a yaw angular velocity.

7. A vehicle control method that controls a vehicle that travels by driving a motor, the vehicle control method comprising:
deriving a target torque by adding, to a requested torque corresponding to an acceleration request, a fluctuation torque that fluctuates cyclically, and controlling a torque of the motor, based on the derived target torque; and
changing one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.

8. The vehicle control method according to claim 7, further comprising
causing the fluctuation range of the fluctuation torque, the cycle of the fluctuation torque, and the waveform of the fluctuation torque to be constant regardless of a magnitude of the requested torque.

9. The vehicle control method according to claim 7, further comprising
correcting the fluctuation range of the fluctuation torque, the cycle of the fluctuation torque, and the waveform of the fluctuation torque, in accordance with a magnitude of the requested torque.

10. The vehicle control method according to claim 7, further comprising
determining whether to add the fluctuation torque to the requested torque, based on a traveling mode.

11. The vehicle control method according to claim 7, further comprising
bringing the cycle of the fluctuation torque close to or away from a reciprocal of the torsional resonance frequency of the wheel mounted on the vehicle, based on any of the speed of the vehicle, the longitudinal acceleration of the vehicle, the vehicle body slip angular velocity of the vehicle, the self-aligning torque of the vehicle, the road surface friction coefficient, and the turning state of the vehicle.

12. A vehicle control apparatus configured to control a vehicle that travels by driving a motor, the vehicle control apparatus comprising
circuitry configured to derive a target torque by adding, to a requested torque corresponding to an acceleration request, a fluctuation torque that fluctuates cyclically, and control a torque of the motor, based on the derived target torque, wherein
the circuitry is configured to change one or more of a fluctuation range of the fluctuation torque, a cycle of the fluctuation torque, and a waveform of the fluctuation torque, based on any of a speed of the vehicle, a longitudinal acceleration of the vehicle, a vehicle body slip angular velocity of the vehicle, a self-aligning torque of the vehicle, a road surface friction coefficient, a turning state of the vehicle, and a torsional resonance frequency of a wheel of the vehicle.
